(19) United States
(12) Patent Application Publication
(10) Pub. No.: US 2008/0267159 A1
(43) Pub. Date: Oct. 30, 2008

(54) Method and System for Providing Communication Between Several Nodes and a Master

(75) Inventors: Per Mattsson, Halmstad (SE); Henrik Ehrnlund, Halmstad (SE)

Correspondence Address: MERCHANT & GOULD PC, P.O. BOX 2903, MINNEAPOLIS, MN, 55402-0903, US

(73) Assignee: EMWITECH HOLDING AB, Halmstad (SE)

(21) Appl. No.: 11/630,095

(22) PCT Filed: Jun. 20, 2005
(86) PCT No.: PCT/SE05/00979

§ 371 Date: Mar. 25, 2008

(30) Foreign Application Priority Data
Jun. 18, 2004 (SE) 0401574-9

(51) Int. Cl. H04J 3/00

(52) U.S. Cl. 370/345

(57) ABSTRACT

A method for communication between several nodes and a maste: in a communication network, wherein each node is assigned a time slot in which to transmit. The nodes are arranged in groups, so that the first group comprises all nodes inside the coverage area of the master. The second group is outside the coverage area of the master but inside the coverage area of any node of the first group, etc. Any node reaches the master or is being reached by the master via a node in a previous group in a multi-hop approach. The time slots are assigned in dependence of the distance to the master. In a message period, in which the master sends a message to any node, the first group is assigned a first group of time slots, and the second group is assigned a second group of time slots, following the first group of time slots, etc. In this way, the message from the master can be sent out to all nodes in a single message period. When a node wants to send information to the master, the time slots are arranged in the opposite order, in an information period, which means that the information can reach the master in a single information period.

### AREA OF INVENTION

The present invention relates to a method and a system for providing communication between several nodes and a master station, and more specifically for power saving operation of the nodes therein.

### BACKGROUND OF INVENTION

Wireless communication between a sensor device and a control station is previously known. A system may comprise a plurality of such sensor devices. When the system and the senor devices are distributed over a large surface area, it may be difficult for each sensor device to communicate directly with the control station or master station.

To solve this situation, it is known to allow each sensor device to also act as a repeater for transmitting signals from more remotely arranged sensor devices to the master station.

Alternatively, or in addition, separate repeater stations may be added, which only act for retransmitting the signals.

Additionally, there may be included in the system actuator devices that respond on signals in the system, such as a relay or a contact closing or breaking an electric circuit.

In the specification below, each sensor device or repeater station or activator device is called a node.

The sensor included in a sensor device may be any type of sensor, such as an infrared detector for sensing the presence of a person in a room, such as for intrusion alarms. The sensor may be a temperature sensor in a heat control system for a building. The sensor may be a camera unit, etc.

Each node comprises a receiver (Rx) and a transmitter (Tx) and suitable control circuits, normally a microprocessor and associated memory including software required for the node. If the node is a sensor node, the node also comprises a sensor and associated hardware and software. If the node is an actuator device, the node also comprises suitable actuator members and associated hardware and software.

WO 97/02677 discloses a system for controlling the lightings in a building and comprises several nodes arranged in several tiers, each communicating with a controlling microprocessor via a lower tier. A message from the micro controller to a specific node may be transmitted via several routes and may be transmitted in circles in the system. The system comprises measures for counteracting such circulating messages. The nodes are connected to wired current supply.

A problem with this previously known system is that the nodes need to be installed where current supply is present. If current supply is not present, each node needs to be powered by battery. In such a connection, power saving may be of particular importance.

This problem has been discussed in US 2004/0083833, in which power saving is obtained by assigning time slots when communication can take place between nodes, whereby the nodes may be sleeping between such time slots. However, if such time slots occur seldom, the response time of the system may be slow.

### DISCLOSURE OF THE INVENTION

An object of the invention is to provide a method and a system, in which the nodes may be powered by batteries, and batteries saving modes are arranged, while at the same time providing a sufficient fast response time of the system.

According to a first aspect of the invention, there is provided a method for communication between several nodes and a master in a communication network, wherein each node is assigned a time slot in which to transmit. Each node is assigned the time slot in dependence of the nodes position in relation to the master. A first group of nodes, which are inside a coverage area of the master may be assigned a first group of time slots, and a second group of nodes, which are outside the coverage area of the master but inside the coverage area of a node in said first group, may be assigned a second group of time slots. The first group of time slots may be arranged before said second group of time slots in a message period, so that a message sent from the master before the first group of time slots is received by the first group of nodes, and retransmitted during the first group of time slots for receipt by the second nodes, and further retransmitted during the second group of time slots, so that the message is transmitted and retransmitted during a single message period. The first group of time slots may be arranged after said second group of time slots in an information period, so that information sent from a node in the second group of nodes during the group of second time slots is received by a node in the first group of nodes and retransmitted to the master during said first group of time slots, so that the information is received by the master during a single information period. The message period may be followed by an information period, which is followed by a sleep period.

In another aspect, there is provided a system for communication between several nodes and a master in a communication network, wherein each node is assigned a time slot in which to transmit. Each node is assigned the time slot in dependence of the nodes position in relation to the master. A first group of nodes, which are inside a coverage area of the master may be assigned a first group of time slots, and a second group of nodes, which are outside the coverage area of the master but inside the coverage area of a node in said first group, may be assigned a second group of time slots. The first group of time slots may be arranged before said second group of time slots in a message period, so that a message sent from the master before the first group of time slots is received by the first group of nodes, and retransmitted during the first group of time slots for receipt by the second nodes, and further retransmitted during the second group of time slots, so that the message is transmitted and retransmitted during a single message period. The first group of time slots may be arranged after said second group of time slots in an information period, so that information sent from a node in the second group of nodes during the group of second time slots is received by a node in the first group of nodes and retransmitted to the master during said first group of time slots, so that the information is received by the master during a single information period.

In a further aspect, there is provided a program product embodied on a computer readable medium, comprising program code, which when executed on a computer performs one or several of the above-mentioned method steps.

### BRIEF DESCRIPTION OF DRAWINGS

Further objects, features and advantages will appear from the following description of several embodiments of the invention with reference to the appended drawings, in which:

FIG. 1 is a diagram of a system comprising a control station and several nodes according to an embodiment of the invention;

FIG. 2 is a schematic diagram showing assignment of time slots during a message period;

FIG. 3 is a schematic diagram showing assignment of time slots during an information period;

FIG. 4 is a block diagram of a node according to an embodiment of the invention;

FIG. 5 is a schematic diagram of a signal transmitted by the node or the master;

FIG. 6 is a schematic diagram showing assignment of time slots during a shortened information period;

FIG. 7 is a flow scheme of a method of operating a node before it is installed;

FIG. 8 is a flow scheme of a method of operating a node before it is installed, at receipt of a signal;

FIG. 9 is a flow scheme of a method of operating a node for possible retransmission of an install request; and

FIG. 10 is a flow scheme of a method of operating a node for handling an install response.

### DETAILED DESCRIPTION OF EMBODIMENTS

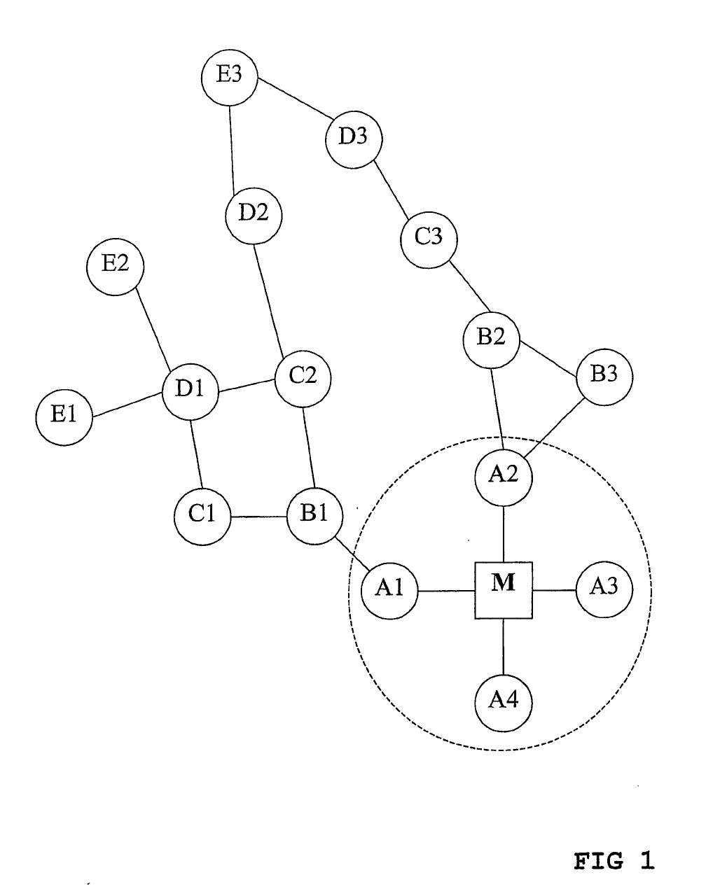

FIG. 1 discloses a master station M and several groups of nodes A1-A4; B1-B3; C1-C3; D1-D3; and E1-E3.

In the first group of nodes A1-A4, the nodes are arranged at a distance from the master M so that the nodes can communicate directly with the master. Thus, nodes A1-A4 are within the coverage area of master M and the master M is within the coverage area of each of the nodes A1-A4.

In the second group of nodes, B1-B3, the nodes are within the coverage area of at least one of the nodes in the first group of nodes A1-A4, but outside the coverage area of the control station M. In other words, the nodes in the second group of nodes B1-B2 need to use a node in the first group of nodes to reach the master M and vice versa. The same is true for each of the groups of nodes C1-C3; D1-D3 and E1-E3, i.e. each node requires to use one or several nodes in the previous groups to reach the master M. The nodes are arranged in a system requiring the outer nodes to communicate with the master via one or several inner nodes, in a multi-hop system.

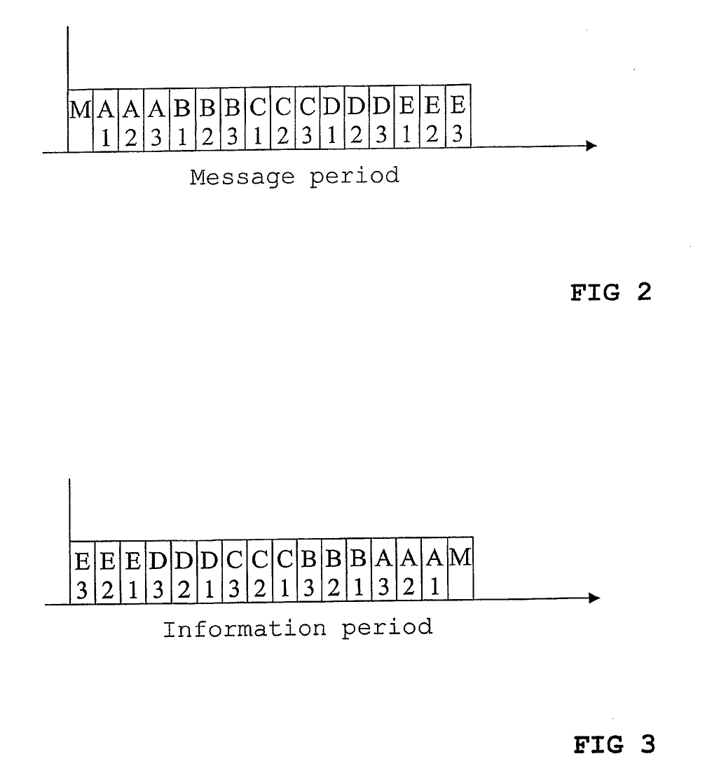

Each node is assigned a time slot, in which it is allowed to transmit. The assignment of time slots is made in the following manner. The four nodes A1-A4 in the first group are assigned the first four time slots. The three nodes B1-B3 in the second group are assigned the following three time slots, etc. The assignments appear from FIG. 2. The time slots form together an active period. Each time slot may be 0.1 ms. If there are 16 time slots, as in the example of FIG. 1, the time period of the active period is 1.6 ms.

Because of the assignment of the time slots, a message sent by the master M will reach all the nodes in as short time as possible. If the master M sends a message at time zero, the node A1 retransmits the message in time slot A1, the node A2 retransmits the message in time slot A2 etc, until the message has reached all the nodes at the end of time slot E3. This period is called a message period, when messages are sent from the master to each of the nodes.

If the nodes want to send information to the master M, such information is sent in an information period. The time slots in the information period are assigned in the opposite order compared to the message period, as appears from FIG. 3. If information is to be sent from node E3 via nodes D2, C2, B1 and A1 to the master M, the information is sent in the time slots assigned to each node, and will reach the master within the same information period, as clearly appears from FIG. 3.

An active period may comprise one or several of each of the message period and information period. If the system is set up for collecting information from sensors, which should be sent from the sensors to the master, only information periods are required. In this case, an active period comprises an information period followed by a sleep period.

The time duration of the sleep period is dimensioned so that maximum power saving of the battery power is obtained, while at the same time a sufficient reply time of the sensors is obtained. If it is sufficient to obtain information from the sensors each second, the sleep time is 0.9984 seconds and the active information period is 0.0016 seconds. The sleep period may be adjustable and adaptable by any system and control algorithm.

In another situation, each active period comprises a message period followed by an information period and a sleep period. In this situation, the master M may send messages to the nodes in the message period and collect information during the information period.

It is mentioned that each node only transmits in its assigned time slot, which means once per message or information period. Of course, the node only transmits if there is a need for transmission, such as the fact that a sensor associated with the node wants to deliver information to the master, or the node is to act as a repeater for messages or information. The node only consumes power when it is actively transmitting.

During the message period and the information period, the node is also active and listens for messages intended for the node. The node also listens for messages or information to be resent to another node or to the master. However, during the set-up of the system, the nodes are informed of the nodes that may communicate with the relevant node, and stores such information in a memory of the node. For example, node B1 may receive a message from node A1, which has to be sent in time slot A1 of a message period. The node B1 may also receive information from node C1 and C2, which may only be sent during time slots C1 and C2 in the information period. Consequently, node B1 needs to actively listen to the traffic during these three time slots. All the other time, the node B1 can be powered down to preserve battery power.

From the above, it is evident that a message and information system is provided in which efficient power saving may be obtained while at the same time a fast response time is maintained. The active periods are maintained as small as possible.

Since the nodes in the first group often are operating as repeater nodes, the battery of these nodes may be drained rapidly. However, the master may be arranged to control the traffic in a way that takes best advantage of the battery status of each of the nodes. Thus, the master M is provided with the ability to control how the nodes operate in order to guide the traffic to the nodes having less traffic or better battery status or according to any other optimization parameter. The inner nodes may be provided with several batteries or with batteries having higher capacity.

Each node 10 comprises an antenna 11 for receiving and transmitting signals over the air. The antenna is connected to a receiver 12 and a transmitter 13. The receiver 12 and transmitter 13 are controlled by a controller or microprocessor or CPU 14 according to known technique. The CPU 14 is connected to a memory 15, which comprises a software program operating the node 10. The memory 15 may further hold information of various types, such as the identity number of the node 10, information of adjacent nodes and time slots thereof, clock information etc. The node 10 is powered by a battery 16, which is connected to the various circuits in the node. A second (or further) battery 17 may be included.

The node 10 may be associated with a sensor 18, such as a temperature sensor or an IR sensor etc. The sensor 18 is controlled by any means such as a CPU 19 connected to a memory 20 and powered by a battery 21. The power may instead be taken from battery 16 or 17. The node may include an actuator (not shown) in addition to the sensor, or separately.

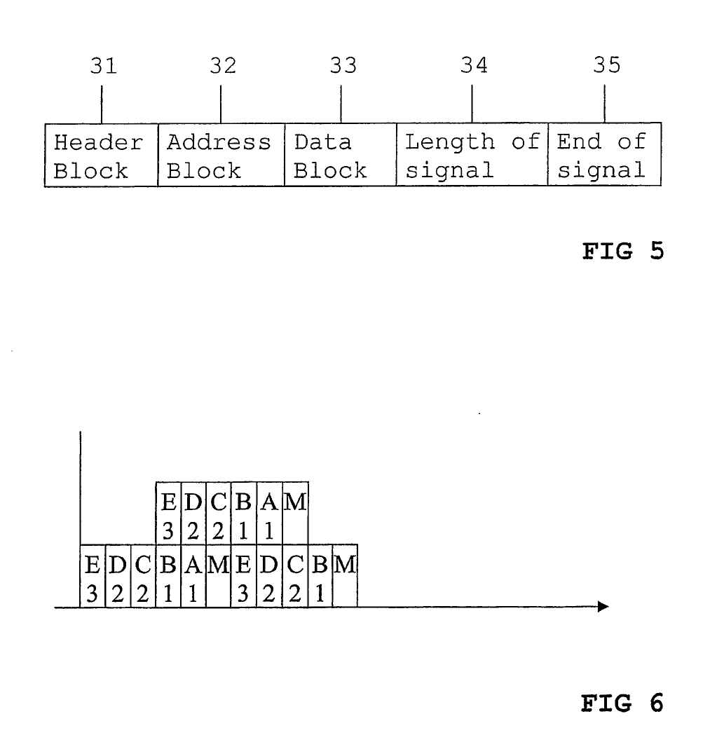

The node is arranged to send signals according to any scheme, such as the scheme shown in FIG. 5. The signal may comprise one or several of the following blocks: a header block 31, an address block 32, a data block 33, a length block 34 and an end block 35.

Since the operation of the system is dependent on the use and assignment of time slots, it is of importance that the nodes and the master are synchronized. This may be obtained by the master sending out synchronization messages at suitable times. Such synchronization messages may be sent for example once per second. Alternatively, such information may be embedded in other messages sent to the nodes, such as messages regarding organization of the nodes.

When a message or information is sent in the system, each node requires some acknowledgement that the message or information has been properly received by the adjacent node or the master. If the message or information is retransmitted by an adjacent node, such retransmission takes the place of an acknowledgement signal, i.e. no specific acknowledge signal is required. Thus, after sending or retransmitting a message or information, the node listens for retransmission of the message or information in the time slots of the adjacent nodes. If a correct retransmission is found, this is an acknowledgment. If no retransmission is found within a predetermined time interval, a new transmission is performed in the next active period. However, the master (for information) and any end node (for messages) send a separate acknowledge message.

If the message or information is too long to fit in the frame of a signal, the system may add further message periods and/or information periods to the active period. For example, if a sensor node wants to send a large amount of information, a flag in the header block 31 is set to indicate that further information is to be sent. Each node that retransmits such information recognizes such a flag and prepares for further transmissions during the sleep period of the other nodes. The node also adds its address or identification to the information, such as in the address block 32, so that the master will know exactly which nodes that should be included. The master initiates one or several information periods. However, only the nodes required for the information transmission and indicated in the information are active.

Suppose that node E3 wants to send further information via nodes D2, C2, B1 and A1 to M. Then, these 5 nodes are maintained active. The master establishes one or several specific information periods that only needs to have three time slots each as shown in FIG. 6. In the first time slot, node E3 transmits a first part of the information and D2 receives the information. During the second time slot, D2 retransmits the information and C2 receives the information, and E3 listens for such retransmission as an acknowledgement. During the third time slot, C2 retransmits the information and B1 receives such retransmission and D1 listens for acknowledgement. During the fourth time slot, B1 retransmits the information, C2 listens for acknowledgement and A1 receives the retransmission from B1. Now, during the fourth time slot, E3 can start the transmission of the second part of the information and D2 can listen for receipt thereof. During the fifth time slot, A1 retransmits the first information to the master, B1 listens for acknowledgment and the master receives the first information. At the same time, during the fifth time slot, D2 retransmits the second part of the information, C2 receives it and E3 listens for acknowledgment. In this way, each part of the information can be sent during three time slots. Several parts of the information may be transmitted in succession. This is a very useful feature if large amount of information should be transmitted to the master, such as if the sensor is a camera sending video clips over the nodes. The number of extra information periods is controlled by the master and the total time must not be longer than the sleep time for the other nodes, because the time slots are used in a different manner than during the normal message and information periods.

In the same manner, extra message periods may be inserted if large amount of messages should be sent to the nodes.

If the information or message is not properly received, the information or message is sent again, until an acknowledgment is received.

The nodes may send at specific frequencies or channels or use frequency hopping as is conventional in order to reduce the risk of interference from other sources. Channel switching may be performed between message periods, information periods or complete activation periods or during sleep time.

The system may be set up in different manners. In an embodiment, the system is self-configurating. The operation may be the following.

When a new node is to be added to the system, the node is introduced adjacent a previously installed node or adjacent the master, to be within the coverage area thereof. The master adjusts the system to an installation mode, for example when a button is pressed, indicating that a new node is to be added. Alternatively, the system may adjust itself to the installation mode, for example at suitable intervals, such as each 30 minutes. The system may also adjust to the installation mode at receipt of a specific signal from the node to be installed.

During the installation mode, all nodes already installed are listening for signals all the time. The node to be installed emits an install request signal and then listens to any result. If there is no result, the node shuts down to save battery power and then sends a new request after some arbitrary time.

If the master receives an install request signal, the master transmits an install response signal, including information about the time slot assigned to the new node and further information required for the node. At the same time, it may be necessary for the master to reconfigure the entire system of nodes and send new time slot information to the respective nodes already installed.

If the request signal is received by an already installed node, the node retransmits the signal towards the master. The new node can hear the retransmission and wait for the time being. When the install request signal has reached the master, the master transmits an install response signal, which is retransmitted the same way to the new node, which thereby becomes installed. In the same way as described above, the master may reconfigure the other nodes.

If the new node is placed between nodes B1 and B2 in FIG. 1, the master may receive the install request signal from both nodes B1, A1 and from nodes B2, A2. In this case, the master selects the route, which is best from some viewpoint, such as traffic load or battery status, etc.

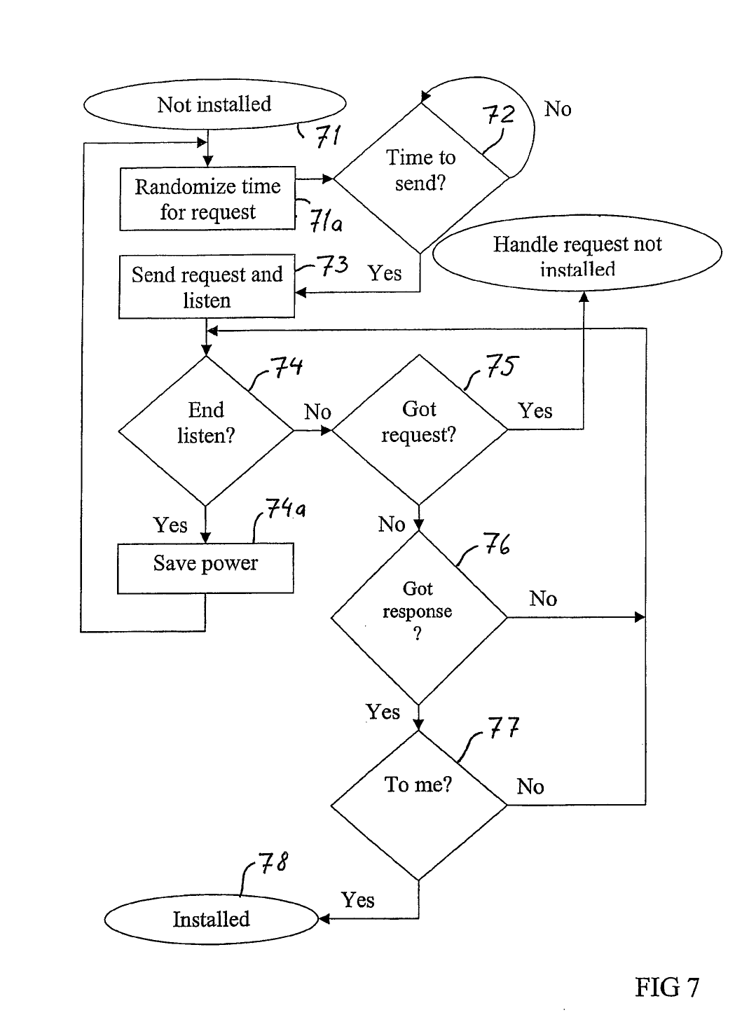

Before the node is installed, and when the node is placed within a network, the node should send a request to be added to the system. All the installed nodes and the master listen for such a packet. The procedure follows the flow scheme of FIG. 7.

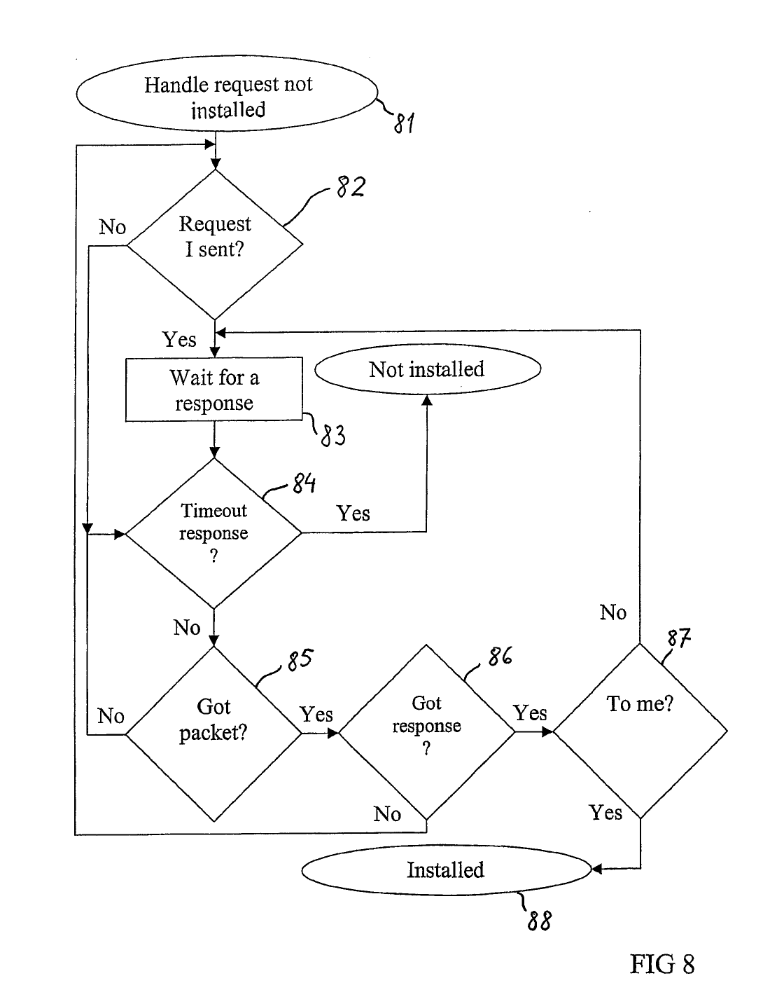

A non-installed node 71 determines a suitable time for sending the install request packet. Since the node has no knowledge of the traffic and time slots, the node determines a randomized time for sending the packet, in step 71a. In decision step 72, the node determines if the time is ready for sending, otherwise, it waits until the randomized time. When the time is right, the node sends an install request packet according to step 73 and then starts listening after any traffic in relation to the sent packet, for a specific time period. If the time period has elapsed, as indicated in step 74 by “yes”, the node shuts down the power in step 74a and waits for the next time to send, whereupon the procedure is started again from step 71a. If the node receives a signal, it determines in step 75 if the signal is an install request. If this is the case, the procedure proceeds to the flow scheme of FIG. 8. However, if the signal is a response, as determined in step 76, it is determined in step 77 if the response is intended for the relevant node, and if this is the case, the node is installed in step 78.

The flow scheme of FIG. 8, starts from the step 75 in FIG. 7, i.e. the node is not installed but has sent an install request. Now, an install request is received, as indicated in step 81. In step 82 it is determined if the install request is the request previously sent by the node, because if this is the case, the install request has been retransmitted by an adjacent node, and is on its way to the master. In step 83, the node waits for a response. In step 84 it is determined if a time out period has lapsed, indicating that the installation is not possible, and a new attempt should be made later. If the time out has not elapsed, and a signal packet is received in step 85, it is determined in step 86 if the signal packet is a response and in step 87 if the response if for the relevant node. If this is the case, the node is installed in step 88.

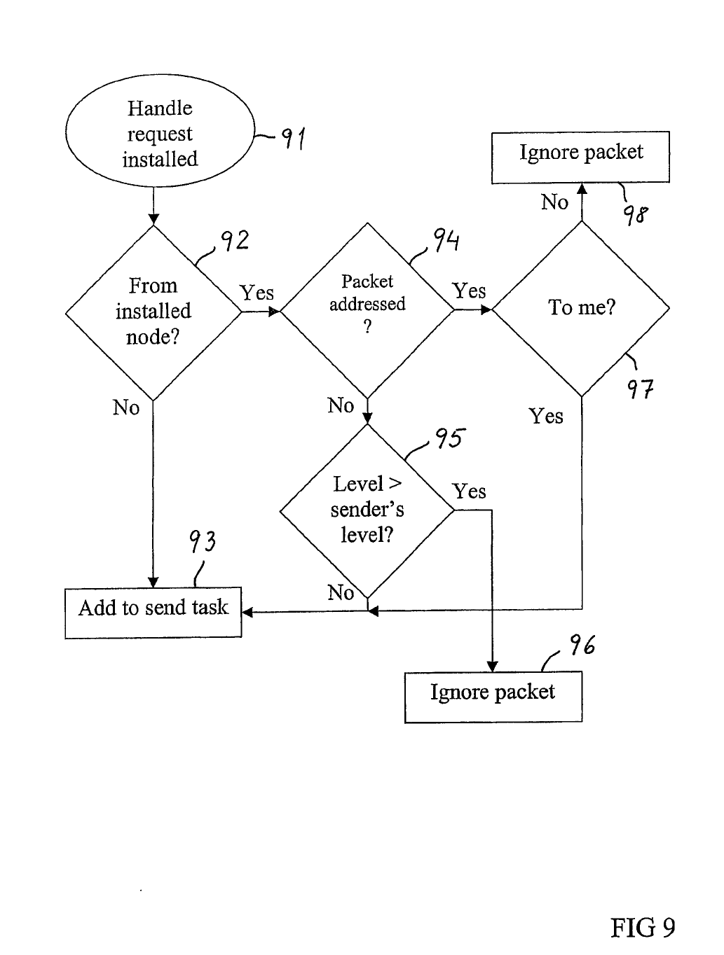

The flow scheme of FIG. 9 shows how an installed node handles an install request signal, as indicated in step 91. If the install request signal is not from an installed node as determined in step 92, the signal should be retransmitted further to the master and is added to the send task in step 93. However, if the install request signal is received from an already installed node, the node determines in step 94 if the packet is addressed. If it is not addressed, it is determined in step 95 if the packet is received from a node having a lower level than the present node. If this is not the case, it is an indication that the packet should be sent further on to the master and added to the send task 93. If the level of the sender node determined in step 95 is higher than the present node, the install request packet is simply ignored in step 96. If the packet is addressed as determined in step 94, it is determined in step 97 if the packet is addressed to the present node, and if not, the packet is ignored in step 98. If the packet is addressed to the present node as determined in step 97, it is an indication that the previous node wants the packet to be sent further on to the master and the packet is added to the send task 93.

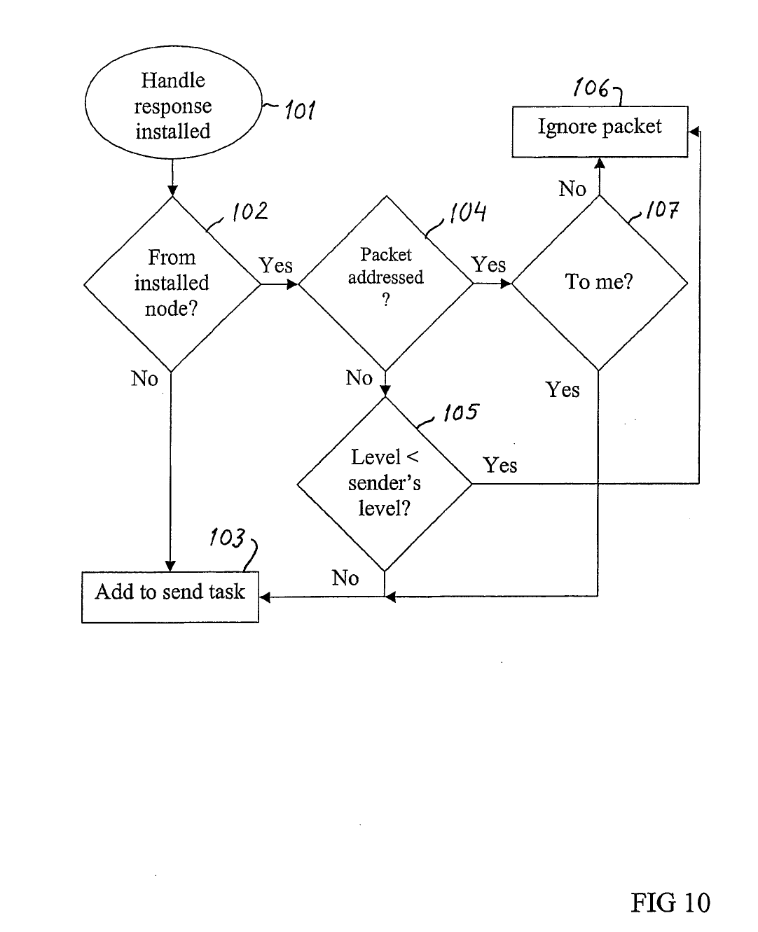

Finally, the flow scheme of FIG. 10 shows how an installed node handles a response, as indicated in step 101. In step 102 it is determined if the received install response is from an installed node, and if this is not the case, the install response packet is added to the send task in step 103. In step 104 it is determined if the packet is addressed, and if not, it is determined if the level of the sender (which is an installed node) is larger than the present node in step 105. If this is not the case, i.e. the packet is a message from the master and outwards, the install response is added to the send task 103, otherwise, the packet is ignored in step 106. If the packet is addressed, as determined in step 104, it is determined in step 107 if the packet is addressed to the present node, and if so, the packet is added to the send task 103, otherwise it is ignored in step 106.

When an installation process is ended, the network assumes its normal operation mode.

It may happen that a node loses its connection with the master of any reason, such as the fact that the battery power is ended, loss of synchronization, the node is physically moved, and an obstacle has entered adjacent the node etc.

One example is that the connection between node B3 and A2 is blocked by a person passing there between. If the node has not received any message during a specific time period, the node enters a lost mode. The master notes that the relevant node has not sent any acknowledgment for the specific time period, and then indicates the node as lost.

If the obstacle disappears, the node may again receive messages and obtain synchronization. In this situation, the node again sends in its previous time slot, and the master may recognize that the node has reentered the system.

If the obstacle is permanent, the lost node may act as a new node and request to be entered in the system as a new node. As shown in FIG. 1, the old node B3 is within the coverage area of node B2 and may be installed as new node C4, since it is now three stages from the master.

If the node is moved, the system recognizes that the new node has the same identification number as a previous node, and reinstalls the old node at a new position and removes the previous installation.

The system in FIG. 1 is shown as having a single master M. However, the system may be configured with several masters. For example, node D1 may act as a second master, and the respective nodes may comprise address information to send information to either the first or the second master or to both. Each master may arrange the nodes in different configurations to achieve the best performance from the network. The master may be connected to a wired power supply, so that it is not dependent on battery power.

Any node may be driven by wired power supply, either all the time or only when the node is at a specific position having wires for connection to the power supply. During the remaining time, the node is powered by batteries.

The respective nodes may comprise information of the addresses of each node. However, it may be more convenient that only the master(-s) has/have full information of the addresses of all nodes in the system. If information is to be sent to a receiving node from a sending node, the sending node sends the information to the closest master, which then reroutes the information to the intended receiving node. The route may be indicated in the packet as address information.

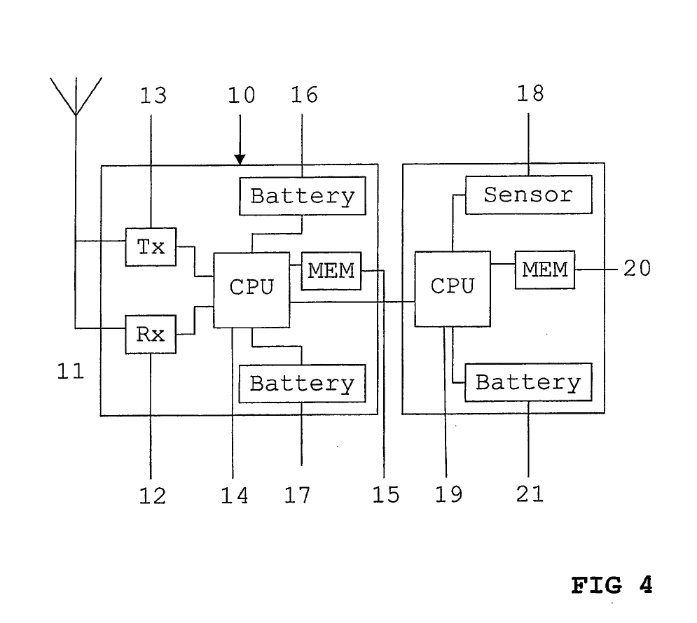

As shown in FIG. 4, the nodes may comprise two batteries. The nodes may be operated using the first battery 16. The node may store information on how many transmissions it has performed until the battery power is ended. Then, the node switches to the second battery and informs the master about the fact that the first battery needs to be exchanged within a certain period, which may be calculated based on the statistics of previous transmissions. If the sensor 18 has a separate battery, the node may obtain power from the sensor battery 21 if needed.

The batteries may be rechargeable batteries, which are charged by for example solar cells. Alternatively, an operator may connect a source of electric energy to the chargeable batteries during a maintenance operation. Alternatively, the batteries are exchanged for new batteries.

The inner nodes A1-A4 etc may carry more traffic than the outer nodes. Thus, several extra nodes may be added which only repeat the traffic, in order to optimize the system. The inner nodes may also be provided with several batteries, such as three of four, etc.

When message or information is retransmitted by a node, that node may add address information to the address block, so that the next receiving node will recognize from where the message or information is obtained and which path or route the message or information has passed. This is particularly useful if there are several routes the information may pass to the master.

Each node stores information of possible adjacent nodes that may communicate with the relevant node or has in fact communicated with the node. The node then only needs to listen to the traffic during the time slots when these nodes are allowed to transmit. Thus, battery power may be saved since the node may be powered down in the time slots there between.

The system may communicate at the frequency band of 868 MHz, but any frequency band may be used. The nodes may send at different channels so that they interfere as little as possible.

In some cases, it is required to wake up all the nodes during a sleep period, for example in an emergency case. This may take place by the master emitting a Dirac pulse. A Dirac pulse is a pulse having infinite short time duration and a unity of energy. Such a pulse consists of all frequencies and can be heard by any receiver. In this case, all nodes need to have a receiver active during the sleep period, or at least during part of the sleep period. At least the master may be provided with a Dirac pulse generator, since the master normally is connected to the mains supply. Some of the nodes can also emit Dirac pulses, which however consumes battery power.

If the system is arranged having only information periods, as shown in FIG. 3, there is no time slot for the master to send synchronization information to the nodes. Although the nodes may have crystals that are very accurate, sooner or later, the nodes will anyhow lose its synchronization. As mentioned before, the master may then send synchronization signals at specific time intervals, for example each minute. Another way to send synchronization signals to the nodes it to add synchronization information to the acknowledgment signal. For example, when node A1 sends information to the master, the master issues an acknowledgment signal including time synchronization to the node A1. In the next active period, when the node B1 transmits information to the node A1, the retransmission of the information by A1 is the acknowledgment to node B1, and this retransmission acknowledgement signal may include the synchronization signal obtained by node A1 from the master in the previous active period. In this way, the synchronization is spread out in the system, one step for each active period.

Above, the nodes are indicated as communicating over the air. However, some of the nodes may communicate via wires or any other communication method, such as (infrared) light, ultrasound, radio signals, magnetic signals, etc. The master may be connected to the Internet or any other network to perform any suitable operation.

When large amount of information should be transmitted, the memory of a sensor device may be insufficient to store the amount of information when waiting for an occasion to transmit the information to the master. In this situation, the node may communicate with adjacent nodes and send some information to these nodes and use the memory of such adjacent nodes for temporary storage of such large information amount.

One example of application of the multihop network is indicated below. The system may be used for control of energy or power consumption in the industry, in the home, or in a vehicle. The relevance for such control is that the combined control of several consumption devices is of large importance.

If the energy cost for a household or a company is determined by the maximal power taken out during a measurement period, the system may be designed to take into account such limitations. A sensor may be arranged to measure the instantaneous power in each outlet, and the signal is sent to a central unit. The node may take a decision by its own, for example if the power taken out exceeds a specific limit, or actuate a command from the central unit, for example if the combined power from each sensor exceeds a specific limit. An alarm can be triggered and a screen may display the relevant data. The sensor may be controlled manually as well as over the multihop network. The sensor may also act as supervisors for the power consumption.

The invention can be implemented in any suitable form including hardware, software, firmware or any combination of these. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

Above, the invention has been described in relation to certain embodiments shown on the drawings. However, such embodiments do not limit the invention but are only for illustrating the invention. The invention may be modified and completed in different manners as occurs to a skilled person reading the specification and such modifications are intended to be within the scope of the invention. The invention is only limited by the appended patent claims.

1. A method for communication between several nodes and a master in a communication network, wherein
a first group of nodes, which are inside a coverage area of the master is assigned a first group of time slots;
a second group of nodes, which are outside the coverage area of the master but inside the coverage area of a node in said first group, is assigned a second group of time slots;
said first group of time slots being arranged after said second group of time slots in an information period, so that information sent from a node in the second group of nodes during the second group of time slots is received by a nod in the first group of node and retransmitted to the master during said first group of time slots, so that the information is received by the master during a single information period;
the method comprising
adding address information by each node during said retransmission by said node.

2. The method of claim 1, wherein said first group of time slots are arranged before said second group of time slots in a message period, so that a message sent from the master before the first group of time slots is received by the first group of nodes, and retransmitted during the first group of time slots for receipt by the second nodes, and further retransmitted during the second group of time slots for receipt by a third group of nodes, which are within the coverage area of said second group of nodes, so that the message is transmitted and retransmitted during a single message period.

3. The method of claim 2, wherein a message period is followed by an information period, which is followed by a sleep period.

4. A system for performing the method of claim 1 for communication between several nodes and a master in a communication network,
a first group of nodes, which are inside a coverage area of the master is assigned a first group of time slots;
a second group of nodes, which are outside the coverage area of the master but inside the coverage area of a node in said first group, is assigned a second group of time slots;
said first group of time slots being arranged after said second group of time slots in an information period, so that information sent from a node in the second group of nodes during the group second time slots is received by a node in the first group of nodes and retransmitted to the master during said first group of time slots, so that the information is received by the master during a single information period;
and
means for adding address information by each node during said retransmission by said node.

5. The system of claim 4, wherein said first group of time slots are arranged before said second group of time slots in a message period, so that a message sent from the master before the first group of time slots is received by the first group of nodes, and retransmitted during the first group of time slots for receipt by the second nodes, and further retransmitted during the second group of time slots for receipt by a third group of nodes, which are within the coverage area of said second group of nodes, so that the message is transmitted and retransmitted during a single message period.

6. A program product embodied on a computer readable medium, comprising program code, which when executed on a computer performs all of the method steps of claim 1.
